(19) United States
(12) Patent Application Publication
(10) Pub. No.: US 2026/0026654 A1
(43) Pub. Date: Jan. 29, 2026

(54) Accessory and Basic Appliance for a Kitchen Appliance, Method and Signal Processing Unit

(71) Applicant: Vorwerk & Co. Interholding GmbH, Wuppertal, DE (US)

(72) Inventors: Volker Wahle, Hamminkeln (DE); Daniel Bambeck, Essen (DE)

(21) Appl. No.: 19/277,498

(22) Filed: Jul. 23, 2025

(30) Foreign Application Priority Data
Jul. 24, 2024 (EP) 24190674.2

(51) Int. Cl. A47J 43/07; A47J 43/046; B01F 35/222; B01F 101/00

(52) U.S. Cl. CPC A47J 43/0716; A47J 43/046; B01F 35/222; B01F 2101/1805

(57) ABSTRACT

An accessory for a kitchen appliance, with a housing and with at least one electrically operated element is disclosed, characterized in that a contact module is provided. The contact module is configured for an electrical contact with a contact module of a basic appliance of the kitchen appliance and for receiving an electrical signal by means of the electrical contact, and in that a signal processing unit is provided. The signal processing unit is configured to generate a first signal component on the basis of the received signal to output a first signal component for supplying power to the at least one electrically operated element, and to output a second signal component with data on the basis of the received signal. A basic appliance compatible therewith, a kitchen appliance, a method and a signal processing unit are also described.

### CROSS-REFERENCE TO RELATED APPLICATION

This application claims priority to European Patent Application No. 24190674.2 filed Jul. 24, 2024, the disclosure of which is hereby incorporated by reference in its entirety.

### BACKGROUND OF THE INVENTION

### Field of the Invention

The present invention relates to an accessory for a kitchen appliance with a housing and with at least one electrically operated element. The present invention further relates to a basic appliance for a kitchen appliance with a housing and with a power supply element, a kitchen appliance, a method and a signal processing unit.

### Description of Related Art

Various kitchen appliances are already known, in particular, for processing raw or semi-finished food products. These kitchen appliances usually have a basic appliance with which separate functional parts interact in order to process a food product depending on the dish, drink or similar that is being prepared. Functional parts are usually sold by kitchen appliance suppliers as accessories, for example, as a cooking vessel, simmering vessel, lid, cutting attachment or mixing attachment. Any part configured to interact with the basic appliance can be provided as an accessory. In general, the accessory and the basic appliance each have compatible interfaces that enable the two components to work together. In particular, by bringing interfaces into interaction with each other a driving can be performed of a movable component of the accessory by means of an electric motor arranged in the basic appliance.

Modern kitchen appliances and their components are increasingly being equipped with electrical and/or electronic components to provide improved support for the user during various food preparation processes. Such electrical or electronic components should then be supplied with power. In addition, the electrical or electronic components provided, for example, sensors, are configured to output data. At the same time, the modularity offered by a basic appliance together with a selection of accessories that can be used should be maintained.

Against this background, the object of the present invention is therefore to improve kitchen appliances and accessories and basic appliances, respectively, of the prior art, in particular, to provide an improved connection between the basic appliance and the accessory, which enables a power supply on the one hand and data transmission on the other hand.

### SUMMARY OF THE INVENTION

The aforementioned object is solved with an accessory for a kitchen appliance with a housing and with at least one electrically operated element in that a contact module is provided, wherein the contact module is configured to electrically contact with a contact module of a basic appliance of the kitchen appliance and to receive an electrical signal by means of the electrical contact, and in that a signal processing unit is provided, wherein the signal processing unit is configured to output a first signal component for supplying power to the at least one electrically operated element on the basis of the received signal and to output a second signal component with data on the basis of the received signal.

The aforementioned object is further solved by a basic appliance for a kitchen appliance with a housing and with a power supply element in that a signal processing unit is provided, in that the signal processing unit is configured to output an electrical signal with a first signal component and with a second signal component, wherein the first signal component is configured to supply power to at least one electrically operated element of an accessory, and wherein the second signal component comprises data, in that a contact module is provided, in that the contact module is configured to electrically contact with a contact module of the accessory for a kitchen appliance, in particular, with a contact module of an accessory according to the present disclosure, in that the contact module is configured to transmit the electrical signal by means of the electrical contact.

The aforementioned object is further solved by a kitchen appliance with an accessory according to the present disclosure and with a basic appliance according to the present disclosure.

The aforementioned object is further solved by a method for operating a kitchen appliance with a basic appliance and with an accessory, in particular, a kitchen appliance according to the present disclosure, in which an electrical connection is formed between the basic appliance and the accessory by bringing a contact module of the basic appliance and a contact module of the accessory into contact, in which a first electrical signal is transmitted from the basic appliance to the accessory by means of the electrical connection, in which at least one electrically operated element of the accessory is supplied with energy on the basis of the transmitted first signal, and in which data is determined by a control device of the accessory and on the basis of the transmitted first signal.

The aforementioned object is further solved by a signal processing unit for a kitchen appliance, in particular, for an accessory according to the present disclosure or for a kitchen appliance according to the present disclosure, with a contact module and with an integrated circuit for processing mixed signals or with an operational amplifier circuit, wherein the contact module comprises a first contact element and a second contact element, wherein the contact module is connected to the integrated circuit or to the operational amplifier circuit, and wherein the signal processing unit is configured to, on the one hand, process a signal and output it to the contact module in such a way that the signal comprises a first signal component for supplying power to an electrically operated element and a second signal component with data, and on the other hand, output a signal component with data on the basis of a signal received by the contact module.

Overall, means and a method are proposed with which both a power supply and a communication are possible, possibly unidirectional or bidirectional, between the basic appliance and accessories associated therewith, for example, in the form of a pot with an integrated heating. The power supply of electrical components of the accessory and the communication and data exchange, respectively, can take place on the basis of a transmission of a single signal sequence so that a reduced number of tangible connecting elements is required. At the same time, the connection remains tangible, i.e., is not based on a non-contact communication standard, so that the means for realizing the signal transmission are of low complexity. As a result, the accessory and the basic appliance can be simplified.

For example, the contact module for the signal transmission can have a maximum of two contact elements, for example, in the form of contact pins or plugs and sockets, respectively, in order to receive or transmit the signal. This reduces the number of contact elements that are usually used in parallel for a power supply and for a data transmission. In addition, further contact elements and mating elements, respectively, can be provided, for example, to supply power to a heating module of the accessory or for earthing.

The solution proposed here reduces the number of contact elements and contact pins, respectively, for example, to just two contact pins, which results in advantages in terms of both cost and application. This results in less soiling of the contact module and therefore less need for cleaning, and in simplified contacting, for example, when inserting an accessory in the form of a cooking pot into the basic appliance. Accordingly, the user-friendliness of the proposed means is increased.

In addition, fewer components and material are required for the contact modules of the accessory and the basic appliance. At the same time, simpler wiring and cable routing, respectively, is required. This means that manufacturing costs can be kept low.

By the signal transmission by means of one physical contact between the contact modules of the accessory and the basic appliance a relatively robust communication can be ensured, and reliable signal transmission, respectively.

A basic appliance in the meaning of the present invention is preferably configured as a base for the use of accessories, in that it comprises an interface for an interacting with at least one accessory. The basic appliance comprises a housing in which an electric motor for driving accessories can be arranged. The electric motor interacts with an accessory inserted on the basic appliance by means of the interface of the basic appliance. The interface can be configured to transmit a mechanical force, for example, by means of a coupling element.

The basic appliance comprises a power supply element. The power supply element can, for example, be configured as an electrical connection for a connection to a household supply network. An example of such a connection is a plug. Alternatively or additionally, the power supply element can have a battery, an accumulator, a generator or further power-producing devices or power storage devices.

The accessory can be insertable directly or indirectly to the basic appliance, wherein for a direct inserting the accessory comprises an interface compatible with the interface of the basic appliance, and wherein for an indirect inserting the accessory is attached to a further accessory, which in turn is inserted directly to the basic appliance. The term “inserting” includes, inter alia, the actions from the list: connecting, coupling, mounting, putting on, attaching, applying and the like. In particular, an accessory is configured to extend the function of the basic appliance, for example, as a cutting unit, mixing unit, cooking unit, weighing unit, simmering unit, steaming unit or covering unit. The function for which the accessory is intended preferably designates the accessory type.

The accessory comprises at least one electrically operated element. One or more elements may be provided, possibly of different types. For example, the accessory can comprise a controller, sensors, actuators and additional elements for extending the function, each of which is to be regarded as an electrically operated element. Examples of an electrically operated element are: sensor, heater, processor, data memory or further elements, wherein the provision of several of such elements individually or in combination is possible.

Preferably, components of the accessory that are intended for heating food are supplied with energy separately, for example, by means of dedicated contact elements.

The accessory and the basic appliance each comprise a contact module. Preferably, the contact module of the accessory and the contact module of the basic appliance are configured to be compatible with each other, for example, as a plug and a socket. Alternatively or additionally, the contact modules are configured for a simple contact, for example, each with a metal surface, wherein the respective metal surfaces come into contact when inserting or attaching the accessory to the basic appliance and thus form an electrical contact.

The contact module of the accessory is configured to receive an electrical signal by means of the electrical contact. Preferably, the contact module of the basic appliance is also configured to receive an electrical signal by means of the electrical contact. For this purpose, the respective contact module can comprise an electrically conductive material composition, for example, with a metal such as copper, at least in sections, preferably in the area of a contact element. Preferably, the contact module of the basic appliance is configured for a detachable electrical contact with the contact module of an accessory and the contact module of the accessory is configured for a detachable electrical contact with the contact module of the basic appliance. For example, a contact can be made by simply inserting and/or plugging in.

The signal comprises a first signal component and a second signal component. Preferably, the first signal component is generated by applying a basic voltage and DC voltage, respectively, between the basic appliance and the accessory and between their respective contact modules, respectively. Thus, the first signal component can be applied by bringing the contact modules into contact and by means of the power supply element. The first signal component can correspond to a DC voltage in the range from 0 to 30 V, in particular, in the range from 5 to 25 V, preferably in the range from 10 to 20 V, more preferably in the range from 10 to 15 V, particularly preferably essentially equal to 12 V.

The second signal component can be generated by the signal processing unit of the basic appliance and/or by the signal processing unit of the accessory, for example, by superimposing a modulation onto the applied basic voltage. The respective signal processing units can be configured to generate a modulation with an amplitude of the order of a few volts, for example, approx. 3.3 V.

It may be provided that the basic voltage is superimposed with both a modulation generated by the signal processing unit of the basic appliance and a modulation generated by the signal processing unit of the accessory. Such a signal, which therefore comprises the basic voltage and both modulations, can be used for bidirectional data transmission, i.e., both from the basic appliance in the direction of the accessory and from the accessory in the direction of the basic appliance. In a transmission direction from the basic appliance to the accessory, the first signal component can be used to supply power to the accessory and its electrically operated elements, respectively, and the second signal component can be used, for example, to transmit control commands for a heating element or a sensor. In the case of a transmission direction from the accessory to the basic appliance, the second signal component can be used to transmit data detected by sensors of the accessory, for example, or information from a data memory of the accessory, such as an accessory ID, to the basic appliance.

Preferably, the signal processing unit of the accessory and the signal processing unit of the basic appliance are formed in the same way or in an essentially mirror-symmetrical structure. This means that a signal modulated by one of the signal processing units can be demodulated by the other signal processing unit. In addition, the signal processing unit of the accessory can have a so-called “Low Drop Out” (LDO) element, with which the first signal component can be extracted from the signal. The first signal component preferably corresponds to a sufficient basic voltage for supplying power to the at least one electrically operated element of the accessory. In particular, the first signal component may comprise a carrier frequency whose magnitude depends on a data rate achieved for the signal. With a high carrier frequency, improved stability and a low susceptibility, respectively, to interference of the signal can be achieved.

In addition, the second signal component preferably corresponds to a modulated portion of the signal. The modulation can, for example, have a pulse-like shape or a rectangular shape in the representation of the signal amplitude over time. Such a second signal component can be easily extracted and separated, respectively, from a carrier signal, for example, the first signal component, using a low-pass filter, a high-pass filter or a combination thereof. Furthermore, the modulation can correspond to a so-called on-off key modulation. This allows a high data rate to be achieved.

The second signal component comprises data. For this purpose, the modulations of the signal can correspond to information pieces that may be possibly coded or expressed in bit form. For example, the signal processing unit may be configured to process, receive or transmit a signal according to a UART (Universal Asynchronous Receiver Transmitter) protocol. Examples of the data that can be carried by the second signal component are: information pieces detected by sensors, for example, by Hall sensors, temperature sensors, accessory recognition unit; an accessory-specific information piece, such as an identification number or a unique identification information piece; voltage variant and calibration values, status values, status information pieces or firmware updates, although this list is not exhaustive. Accordingly, the kitchen appliance can be controlled depending on the data determined from the second signal component.

With a signal that comprises a first signal component with a specific basic signal and a basic voltage, respectively, for example, approx. 12 V DC, and a second signal component with an on-off key modulation, an operating voltage can be transmitted robustly, in particular, taking into account the resistance that is present when the contact modules are physically contacted. In addition, a high data rate can be achieved with such a signal, for example, over 30,000 baud, in particular, over 35,000 baud, preferably over 38,000 baud. Furthermore, a manageable interference emission and relatively interference-resistant communication, respectively, can be achieved with such a signal, wherein only individual signal errors occur.

The control device preferably comprises a processor with a storage medium. In particular, a computer program with commands can be stored in the storage medium, the executing of which by the processor causes the kitchen appliance to carry out an operating method. A database can be stored in the storage medium. Examples of data stored in the database are accessory information pieces, preparation instructions, food information pieces, user information pieces, sensor data or further information pieces.

Various embodiments of the accessory, the basic appliance, the kitchen appliance, the method and the signal processing unit are described below, with the individual embodiments each applying independently of one another to the accessory, the basic appliance, the kitchen appliance, the method and the signal processing unit. Furthermore, the individual embodiments can be combined with each other as desired.

In one embodiment of the accessory, it is provided that a control device is provided and that the control device is configured to determine the data from the second signal component output by the signal processing unit.

Thereby, depending on the component of the kitchen appliance, i.e., the basic appliance or the accessory that has such a control device, data can be determined from the received signal and can be taken into account for controlling. For example, an accessory identification information piece transmitted by the accessory by means of the second signal component can be used by the control device to recognize the accessory and thus enable corresponding functions. Sensor information pieces can also be transmitted from the accessory to the basic appliance and used by the control device of the basic appliance, for example, to control the electric motor or to adjust heating parameters. Furthermore, control commands that are transmitted to the accessory by the basic appliance can be carried out by the control device of the accessory.

The at least one electrically operated element of the accessory can comprise the control device.

In one embodiment of the accessory, it is provided that the data corresponds to control information pieces for the at least one electrically operated element.

In this way, control information pieces provided by the basic appliance can be transmitted to the accessory by means of the second signal component and processed there, for example, by a control device of the accessory, and possibly taken into account to carry out a corresponding controlling. Examples of control information pieces include calibration values, firmware updates and commands to activate an actuator, although this list is not exhaustive.

If the signal is transmitted from the accessory to the basic appliance, the present embodiment enables the accessory to provide control information pieces to the basic appliance. For example, control information pieces of a preparation instruction stored in the accessory can be made available to the basic appliance. Furthermore, states of the accessory can be transmitted, for example, an information piece about a detected additional accessory such as a lid or insulation, measured values from temperature sensors, measured values from HALL sensors, information pieces about error states, firmware version numbers and the like, although this list is not exhaustive.

In one embodiment of the accessory, it is provided that the signal processing unit is configured to output a modulated electrical signal on the basis of a basic signal transmitted by contact with the basic appliance, in particular, on the basis of a basic voltage applied by contact with the basic appliance, wherein the modulated electrical signal comprises a signal component with data, and that the contact module is configured to transmit the modulated electrical signal output by the signal processing unit to the basic appliance by means of the electrical contact.

The signal processing unit of the accessory is configured to transmit a signal in addition to the function of receiving a signal. This enables bidirectional data transmission.

For this purpose, the signal processing unit can comprise a transmit path on the one hand and a receive path on the other hand. In particular, the receive path and/or the transmit path can be configured for a data transmission in accordance with a UART protocol.

In one embodiment of the accessory, it is provided that at least one sensor is provided for outputting measurement data, and that the data of the signal component of the modulated electrical signal output by the signal processing unit corresponds to the measurement data.

The at least one electrically operated element may comprise the at least one sensor. In particular, the signal processing unit of the accessory can be configured to modulate and output an electrical signal in such a way that the output signal comprises a signal component with data, wherein the contact module is configured to transmit the electrical signal modulated by the signal processing unit by means of the electrical contact, and the accessory can comprise a control device and the at least one sensor, for example, two sensors. This allows that measurement data can be detected by the sensors at the accessory, processed by the control device and transmitted to the basic appliance via the signal transmission by the signal processing unit. For this purpose, the control device can be connected to the signal processing unit for communication and data transmission, respectively, in accordance with a UART protocol.

The at least one sensor can be configured as an analog sensor or as a digital sensor and can be connected to a control device of the accessory for the transmission of detected measurement data or data such as calibration values or firmware. Several sensors can be connected to the control device of the accessory, which are either connectable digitally via 12C, such as a Hall sensor for accessory detection or for detecting an insulation condition, or are analog sensors, for example, temperature sensors or a negative temperature coefficient thermistor (so-called “NTC”).

In one embodiment of the accessory, the contact module comprises a first contact element and a second contact element.

In one embodiment of the basic appliance, it is provided that the contact module comprises a first contact element and a second contact element.

As a result, the power supply of the electrically operated element of the accessory and also the data transmission can be carried out using only two contact elements, for example, in the form of contact pins. Compared to an alternative solution with more than two contact elements, a two-pin solution offers the advantage of material savings and cost savings, respectively, in the manufacture of the kitchen appliance respectively the accessory and the basic appliance. In addition, this simplifies the inserting of the accessory to the basic appliance and thus increases user-friendliness.

Preferably, the first contact element corresponds to a positive pole and the second contact element corresponds to a negative pole. In addition, the contact module can comprise at least one element from the following list, wherein this list is not exhaustive: an earthing element, a protective conductor, a heating supply element, a coupling element for mechanical coupling of a mechanical functional element of the accessory with the electric motor of the basic appliance, a locking element for mechanical locking of the accessory with the basic appliance.

Furthermore, the first contact element and the second contact element of the contact module of the accessory can be configured for a respective electrical contact with a first contact element and with a second contact element of the contact module of the basic appliance.

In a particular embodiment of the accessory, the first contact element and the second contact element, and possibly also the earthing element of the contact module, are configured as a male plug element. In a corresponding embodiment of the basic appliance, the first contact element and the second contact element, and possibly also the earthing element of the contact module, are configured as a female plug element. This means that the contact module of the accessory and the contact module of the basic appliance are compatible with each other.

In a further embodiment of the accessory, it is provided that the contact module also comprises an earthing element in addition to the first contact element and the second contact element. The earthing element can be configured to earth an individual component of the accessory or the entire accessory by means of a contact with a corresponding earthing mating element of the basic appliance.

In addition, the contact module of the accessory can also comprise at least one, preferably two, heating supply contact elements. This allows a heating element of the accessory to be supplied with energy separately. As a rule, the energy requirement of heating elements is higher than the energy requirement of electronic components, so that a separate energy supply can certainly be advantageous.

In a further embodiment of the basic appliance, it is provided that the contact module, in addition to the first contact element and the second contact element, also comprise an earthing mating element. The earthing mating element can be configured to earth an individual component of the accessory or the entire accessory by means of a contact with a corresponding earthing element of the basic appliance.

In addition, the contact module of the basic appliance can also comprise at least one, preferably two, heating supply contact mating elements. This allows a heating element of the accessory to be supplied with energy separately. As a rule, the energy requirement of heating elements is higher than the energy requirement of electronic components, so a separate energy supply can certainly be advantageous.

In one embodiment of the accessory, it is provided that a receiving area having a wall is provided for receiving food, that a component is arranged on the wall, and that the at least one electrically operated element is integrated in the component.

This type of accessory enables food to be received for preparation while avoiding contact between the received food and the electrically operated element. This maintains hygienic conditions and extends the service life of the electrically operated element. In addition, by integrating the electrically operated element into the component, wear and tear and hazards for the user are avoided.

Examples of the component are: handle element, cover, insulating element, removable additional component or a combination thereof, wherein this list is not exhaustive.

In one embodiment of the basic appliance, a control device is provided, wherein the control device is configured to output control information pieces, and the signal processing unit is configured to modulate and output the electrical signal to be transmitted by the contact module in such a way that the data of the second signal component corresponds to the control information pieces.

In this way, control information pieces can be provided by the basic appliance and taken into account by a control device of a receiving accessory for controlling, for example a sensor.

In one embodiment of the basic appliance, it is provided that the contact module is configured to receive an electrical modulated signal by means of the electrical contact, and that the signal processing unit is configured to output a signal component with digital data on the basis of the received modulated signal.

This allows data to be transmitted from an accessory to the basic appliance, enabling bidirectional data transmission.

For this purpose, the signal processing unit can be configured to demodulate the received, modulated signal and then forward it to a control device of the basic appliance.

In one embodiment of the method, it is provided that a second electrical signal is transmitted from the accessory to the basic appliance by means of the electrical connection, and that data is determined by a control device of the basic appliance and on the basis of the second signal.

This ensures reliable, robust bidirectional data transmission between the accessory and the basic appliance: the first signal is used to transmit data from the basic appliance to the accessory and the second signal is used to transmit data from the accessory to the basic appliance.

In a specific embodiment of the method, it may be provided that the contact module of the basic appliance is brought into contact with the contact module of the accessory in such a way that a basic voltage, for example approx. 12 V DC, is applied between the contact module of the basic appliance and the contact module of the accessory, and the accessory and individual components of the accessory, respectively, are earthed.

In addition, the signal processing unit of the basic appliance can superimpose a first modulation, for example, with an amplitude of approximately 3.3 V, on the basic voltage applied in this way, wherein the modulation is an on-off key modulation which corresponds to digital data which has been provided to the signal processing unit by the control device of the basic appliance.

Furthermore, the signal processing unit of the accessory can superimpose a second modulation, for example, with an amplitude of approximately 3.3 V, onto the base voltage applied between the basic appliance and the accessory, wherein the modulation is an on-off key modulation corresponding to digital data provided to the signal processing unit by the control device of the accessory

In a particular embodiment, it is provided that the first signal component comprises an essentially constant time characteristic and that the second signal component comprise current pulses.

In this way, a power supply of the electrically operated element at the accessory can be performed by means of just two contact elements of the contact module, and data transmission can thus be performed in so-called half-duplex by current pulses on the supply line and the associated fluctuation in the supply voltage of these two contact elements.

In particular, the second signal component can correspond to fast and abrupt, respectively, current changes. In this way, the second signal component can be determined by a high-pass filter and separated from the first signal component, respectively.

In addition, the essentially constant time characteristic of the first signal component means that it can be determined by a low-pass filter and separated from the second signal component, respectively.

For this purpose, the signal processing unit can comprise a high-pass filter and a low-pass filter. Furthermore, the signal processing unit can also use the low-pass filter to compensate for slow signal fluctuations and changes in power consumption, respectively, in order to prevent communication interference.

In one embodiment, it is provided that the signal processing unit comprises an operational amplifier circuit, wherein the operational amplifier circuit is configured to extract the second signal component from the received signal by means of a comparison function.

In both the basic appliance and the accessory, fluctuations in the current flow of the received signal can be detected by means of an operational amplifier circuit, wherein these fluctuations correspond to the second signal component. For this purpose, the operational amplifier can be connected as a comparator and thus can comprise the comparison function. A low-pass filter is used to provide a reference voltage for the comparator from a supply line. This ensures that slow fluctuations in the signal and the current, respectively, (e.g., due to changes in the status of a control device in the form of a microcontroller or sensors and actuators, respectively, of the accessory) are filtered, thus preventing interference during data transmission.

In addition, an input signal for the comparator can be determined using a high-pass filter in order to detect rapid fluctuations in current consumption. On the transmitting side (TXD), the current on the supply line can be increased abruptly with a simple transistor stage by means of a resistor. On the receiving side (RXD), this leads to a corresponding output signal of the comparator on both the basic appliance and the accessory. If the transmitting element, i.e., the basic appliance or the accessory, also receives the transmitted signal at the same time, the transmission function can also be checked. Preferably, both the low-pass and the high-pass filter are set to the appropriate bandwidth of the data to be transmitted.

Furthermore, several sensors can be connected to the control device of the accessory, which are either digitally connectable via 12C, such as a Hall sensor for accessory detection or for detecting an insulation condition, or are analog sensors, for example, temperature sensors or a negative temperature coefficient thermistor (so-called “NTC”). A combination of sensors of different types can result in the power consumption for the accessory being variable within a certain range. Slow changes in power consumption are compensated for by low-pass filtering both on the side of the basic appliance and on the side of the accessory in order to prevent communication interference. As a result, data transmission and communication, respectively, is carried out by transmitting fast and abrupt, respectively, changes in current, which are detected using high-pass filtering.

Further features and advantages of the accessory, the basic appliance, the kitchen appliance, the method and the signal processing unit are shown in the following description of embodiments, with reference being made to the attached drawing.

### BRIEF DESCRIPTION OF THE DRAWINGS

In the drawing shows

FIG. 1 an embodiment of an accessory for a kitchen appliance;

FIG. 2 a detailed view of the interface of the accessory with a contact module from FIG. 1;

FIG. 3 an embodiment of a basic appliance for a kitchen appliance;

FIG. 4 an embodiment of a kitchen appliance in an assembled state;

FIG. 5 a schematic representation of a first embodiment of a circuit diagram for a system with an accessory and with a basic appliance;

FIG. 6 an embodiment of an integrated circuit for processing mixed signals;

FIGS. 7a to 7e a schematic representation of an embodiment of a signal transmitted in the system shown in FIG. 5;

FIG. 8 a second embodiment of a circuit diagram for a system with an accessory and with a basic appliance in a schematic representation; and

FIGS. 9a to 9d a schematic representation of an embodiment of a signal transmitted in the system shown in FIG. 8.

### DESCRIPTION OF THE INVENTION

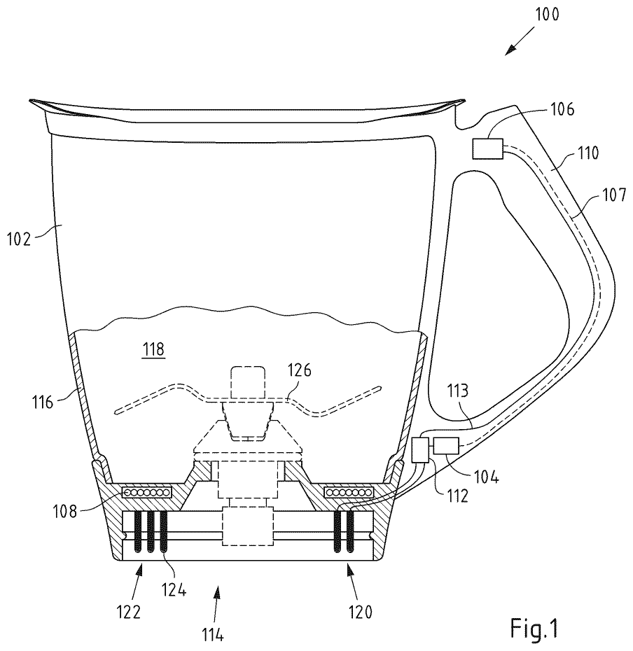

FIG. 1 shows an embodiment of an accessory 100 for a kitchen appliance. The accessory 100 is configured as a cooking vessel and comprises a housing 102, a first electrically operated element in the form of a control device 104, a second electrically operated element in the form of a sensor 106, an 12C connection 107 for data transmission between the control device 104 and the sensor 106, a third electrically operated element in the form of a heating element 108, a component 110 in the form of a handle element, a signal processing unit 112, a cable connection 113 between the signal processing unit 112 and the sensor 106 for supplying power to the sensor 106, and an interface 114 for a connection to a basic appliance.

The housing 102 of the accessory 100 comprises a wall 116, which forms a receiving area 118 for receiving food. The component 110 and the handle element, respectively, is arranged at the wall 116. The control device 104 is connected to the signal processing unit 112 by means of the cable connection 113. The sensor 106 is connected to the signal processing unit 112 by means of the 12C connection 107. The control device 104 and the sensor 106 are integrated in the component 110. In an alternative embodiment, the sensor 106 may be a passive component and may be connected to the signal processing unit 112 by means of the control unit 104. As a result, the direct connection between the signal processing unit 112 and the sensor 106 shown here can be dispensed with.

The interface 114 comprises a contact module 120, a heating supply module 122 and an earthing element 124. The heating element 108 is connected to the heating supply module 122 and the signal processing unit 112 is connected to the contact module 120. Thus, the heating element 108 and the signal processing unit 112 are supplied with separate contacts to the basic appliance.

The signal processing unit 112 is configured to output a first signal component and a second signal component with data on the basis of a signal received by means of the contact module 120 from a then connected basic appliance. The first signal component is then used to supply power to the sensor 106 and the control device 104. The second signal component carries data and is forwarded to the control device 104.

The control device 104 is in turn configured to determine the data from the second signal component and to take it into account when controlling the sensor 106.

The sensor is configured to detect measurement data and to output the measurement data to the control device 104. The control device 104 is in turn configured to process the measurement data and forward it to the signal processing unit 112 for transmission, in this case in accordance with a UART protocol. The signal processing unit 112 is configured to modulate and output an electrical signal in such a way that the output signal is the carrier of the measurement data processed by the control device 104. The contact module 120 is configured to transmit the electrical signal modulated by the signal processing unit 112 by means of the electrical contact to a base appliance that is then connected.

A further accessory 126 in the form of a knife unit 126 is arranged at the housing 102 of the accessory 100, which is configured as a cooking vessel.

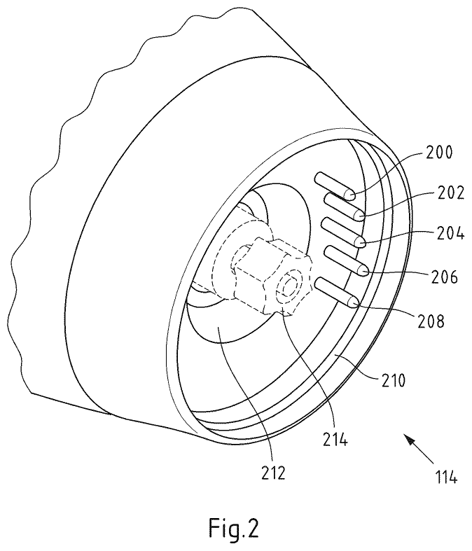

FIG. 2 shows a detailed view of the interface 114 of the accessory 100 of FIG. 1.

The interface 114 comprises a total of five contact pins: a first contact pin 200 and a second contact pin 202 form the contact module 120 and are each configured for electrical contact with corresponding contact mating elements of a basic appliance and for receiving an electrical signal by means of the electrical contact. A third contact pin 204 serves as an earthing element 124 for earthing the accessory 100 by contact with an earthing mating element of the basic appliance. A fourth contact pin 206 and a fifth contact pin 208 are used to supply power to the heating element 108 of the accessory 100, thus forming the heating supply module 122.

In addition to the contact module 120, the heating supply module 122 and the earthing element 124, the interface 114 comprises a connecting element 210 for mechanically connecting the accessory 100 to the basic appliance.

The interface 114 further comprises a penetrating opening 212 for receiving the knife unit 126. The knife unit 126 is formed with a coupling element 214 for coupling with a drive of a basic appliance.

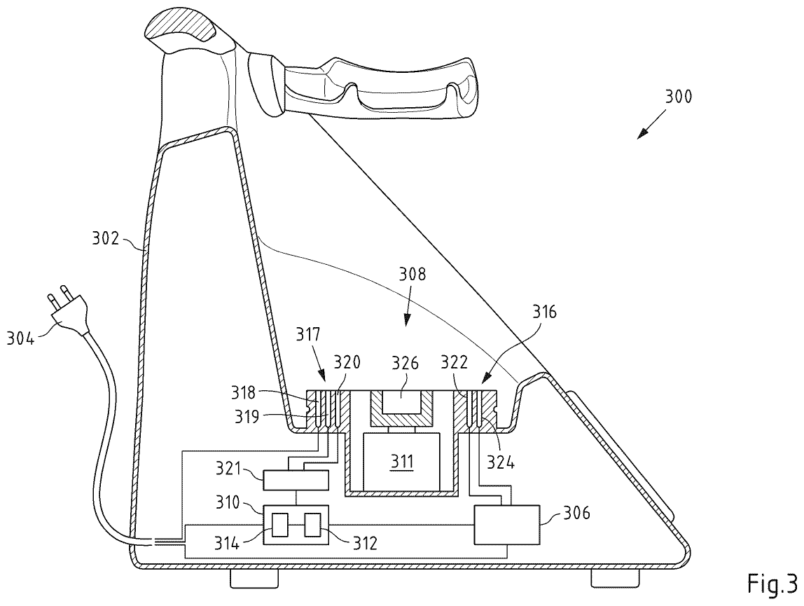

FIG. 3 shows an embodiment of a basic appliance 300 for a kitchen appliance. The basic appliance 300 comprises a housing 302, a power supply element 304, a control device 310, a drive 311, an interface 308 and a signal processing unit 306.

The power supply element 304 is connected to the control device 310 and to the signal processing unit 306. In this way, both the control device 310 and the signal processing unit 306 are supplied with power. The signal processing unit 306 is connected to the control device 310 and to the interface 308.

The control device 310 comprises a processor 312 and a data memory 314 and is configured to output control information pieces, for example, control commands relating to a sensor or firmware, and to forward it to the signal processing unit 306.

The signal processing unit 306 is configured to output an electrical signal with a first signal component and with a second signal component. For this purpose, the signal processing unit 306 can use a voltage provided by the power supply element 304 as a basis and modulate it in such a way that the output signal then comprises the first signal component and the second signal component. The modulation is performed on the basis of a predetermined base signal, in particular, on the basis of a predetermined base voltage, for example, about 12 V DC, to provide the first signal component, and on the basis of the control information pieces output by the control device 310 to provide the second signal component. Thus, the signal processing unit 306 modulates the output signal such that the data of the second signal component corresponds to the control information pieces.

Subsequently, the signal processing unit 306 forwards the modulated signal to the interface 308 and to a contact module 316 of the interface 308, respectively, for transmission to a connected accessory.

The interface 308 comprises a contact module 316, a heating supply contact module 317 and an earthing element 318. The heating supply contact module 317 comprises two counterparts 319, 320 for contact pins, which are connected to a heater controller 321. The contact module 316 has two contact elements 322, 324 in the form of counterparts for contact pins, wherein the contact elements 322, 324 are configured for electrical contact with the contact module 120 of the accessory 100 of FIGS. 1 and 2. The contact elements are configured to transmit the signal modulated by the signal processing unit 306 to the contact elements of a connected accessory 100.

In addition, a coupling counter element 326 is provided for a mechanical coupling of the drive 311 with the coupling element 214 of the accessory.

Overall, the basic appliance 300 is thus configured to transmit a signal to a connected accessory, wherein the signal is simultaneously suitable for supplying power to the accessory 100 and for transmitting data, in this case control information pieces.

In addition, the basic appliance 300 is also configured to receive a signal provided by a connected accessory and to extract data from it.

For this purpose, the contact module 316 of the basic appliance 300 is configured to receive an electrical signal by means of the electrical contact. Furthermore, the signal processing unit 306 is configured to output a signal component with data on the basis of the received signal, for example, by demodulating the received signal. Furthermore, the control device 310 is configured to evaluate the demodulated signal and the extracted signal component, respectively, and to determine data from this.

Thus, the basic appliance 300 is configured for bidirectional data transmission or communication by means of a physical contact with an accessory.

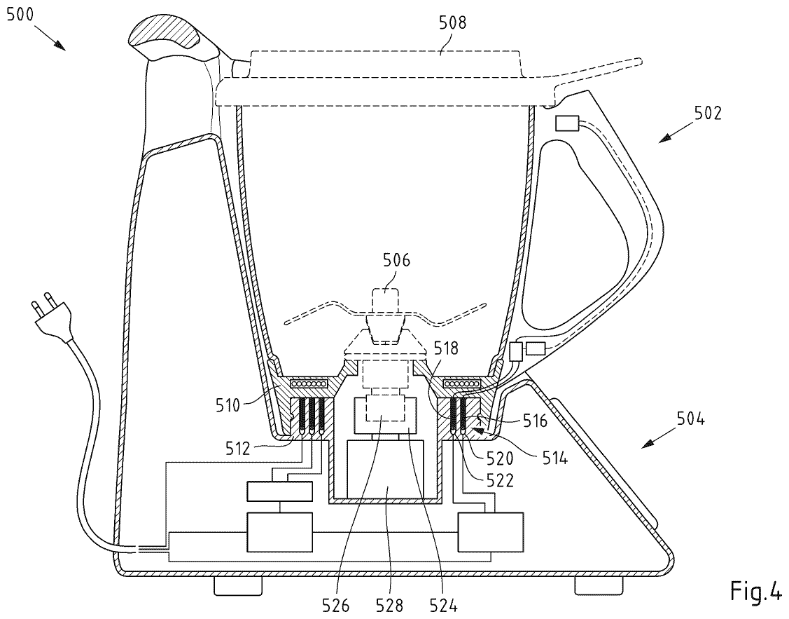

FIG. 4 shows an embodiment of a kitchen appliance 500 in an assembled state. The kitchen appliance 500 comprises an accessory 502, which is configured like the accessory 100 of FIGS. 1 and 2, and a basic appliance 504, which is configured like the basic appliance 300 of FIG. 3. Furthermore, the kitchen appliance 500 comprises a first additional accessory in the form of a knife unit 506 and a second additional accessory in the form of a lid 508.

The interface 510 of the accessory 502 and the interface 512 of the basic appliance 504 are connected to each other. For this purpose, the contact elements 516, 518 of the accessory 502 are brought into contact with the contact mating elements 520, 522 of the basic appliance 504. In addition, the earthing element 524 of the accessory 502 is connected to the earthing mating element 526 of the basic appliance 504.

The interface 512 of the basic appliance 504 further comprises a coupling mating element 528 for coupling with a coupling element 530 of the additional accessory 506, wherein the coupling mating element 528 is configured to transmit a force from the drive 532 of the basic appliance 504 to the additional accessory 506.

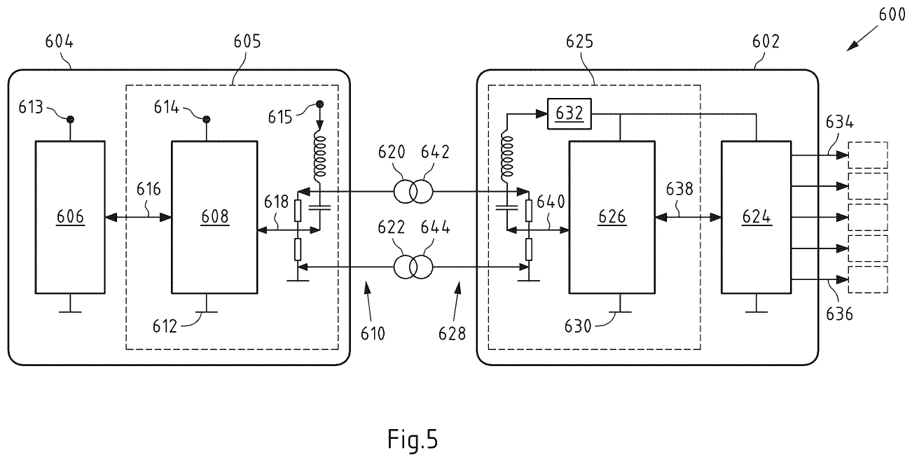

FIG. 5 shows a first embodiment of a circuit diagram of a system 600 with an accessory 602 and with a basic appliance 604 in a schematic representation.

The basic appliance 604 and electrical components of the basic appliance, respectively, are shown schematically on the left-hand side of FIG. 5. This comprises a signal processing unit 605 and a control device 606. The signal processing unit 605 in turn comprises an integrated circuit 608 for processing mixed signals and a contact module 610. The control device 606, the integrated circuit 608 and the contact module 610 are each earthed by means of an earthing contact, such as the earthing contact 612 of the integrated circuit 608. The control device 606 and the integrated circuit 608 are each supplied with a supply voltage. For this purpose, a supply connection 613 is provided at the control device 606 and a supply connection 614 is provided at the integrated circuit 608. The supply connections 613 and 614 provide a supply voltage, for example, approx. 3.3 V. A further supply connection 615 is provided to provide a basic voltage, for example, approximately 12 V. The basic voltage can be used to provide the first signal component by the integrated circuit 608.

The control device 606 and the integrated circuit 608 are connected with each other for bidirectional signal transmission 616. The integrated circuit 608 is also connected to the contact module 610 for bidirectional signal transmission 618. The contact module 610 comprises a first contact element 620 and a second contact element 622.

The accessory 602 and electrical components of the accessory, respectively, are shown on the right-hand side of FIG. 5. This comprises a control device 624 and a signal processing unit 625. The signal processing unit 625 in turn comprises an integrated circuit 626 for processing mixed signals and a contact module 628. The control device 624, the integrated circuit 626 and the contact module 628 are each earthed by means of an earthing contact, such as the earthing contact 630 of the integrated circuit 626. In addition, the signal processing unit 625 comprises a voltage supplier 632 in the form of a so-called “low drop-out”, which is configured to extract a supply voltage, for example, approximately 3.3 V, from a signal received by the contact module 628 and to supply it to the control device 624 and the integrated circuit 626. The received signal can have a higher voltage, for example approx. 12 V.

The control device 624 is configured for a connection with sensors of the accessory, for example, with Hall sensors or temperature sensors, wherein the connection 634, 636 is configured for the transmission of measurement data, calibration values or firmware. In addition, the control device 624 and the signal processing unit 625 and the integrated circuit 626, respectively, are connected with each other for bidirectional signal transmission 638. The integrated circuit 626 is also connected to the contact module 628 for bidirectional signal transmission 640. The contact module 628 comprises a first contact element 642 and a second contact element 644.

FIG. 5 shows a constellation in which the contact module 610 of the basic appliance and the contact module 628 of the accessory are connected to one another via a physical contact so that a signal can be transmitted between the basic appliance 300 and the accessory. For this purpose, the first contact element 620 of the basic appliance is brought into physical contact with the first contact element 642 of the accessory and the second contact element 622 of the basic appliance is brought into physical contact with the second contact element 644 of the accessory.

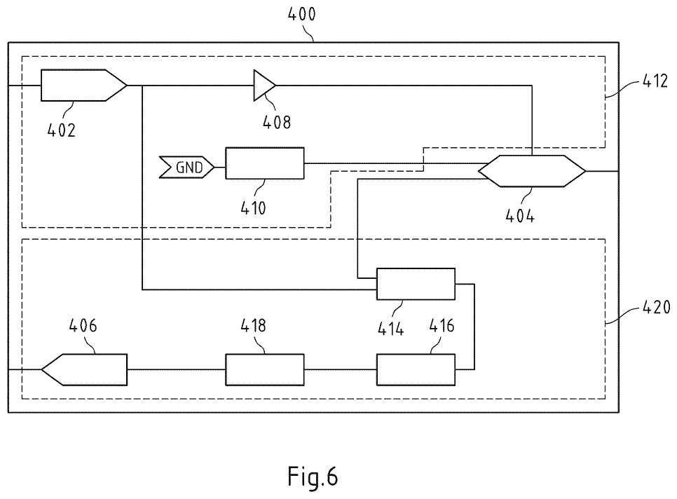

FIG. 6 shows an embodiment for an integrated circuit 400 for processing mixed signals, for example, for a signal processing unit for the accessory of FIG. 5 or for the basic appliance of FIG. 5. The integrated circuit 400 comprises an input channel 402, an input output channel 404 and an output channel 406.

The integrated circuit 400 is provided for processing mixed signals, i.e., for processing both analog and digital electrical (input) signals. For this purpose, the integrated circuit 400 is configured as follows.

The input channel 402 is connected to the input output channel 404 by means of an inverter 408. The input output channel 404 is in turn connected to an oscillator 410. The input channel 402, the inverter 408, the oscillator 410 and the input-output channel 404 together form a transmission path 412. The input channel 402 is configured to receive a signal component with data in digital form from a control device, for example, from the control device of the accessory or from the control device of the basic appliance, and to forward it to the inverter 408. The inverter 408 is configured to invert the signal component with data in digital form by converting high bit states to low bit states and vice versa, and to forward it to the input-output channel 404. The oscillator 410 is configured to output a modulated signal component to the input-output channel 404. The input-output channel 404 is configured to output an electrical signal component with data on the basis of the signal component with digital data and the modulated signal component, for example, to the contact module of the accessory or to the contact module of the basic appliance.

In addition, the input channel 402 is connected to a suppression element 414. The suppression element 414 is in turn connected, on the one hand, to the input-output channel 404 and, on the other hand, to the output channel 406 by means of a conversion module 416 and a filtering module 418. The suppression element 414, the input-output channel 404, the conversion module 416, the filtering module 418 and the output channel 406 together form a receive path 420.

Here, the input-output channel 404 is configured to receive an electrical signal having a signal component with data, for example, from the contact module of the accessory or from the contact module of the basic appliance, and the suppression element 414 is configured to output a signal component on the basis of the received electrical signal component, from which the signal component transmitted by means of the transmission path has been filtered and suppressed, respectively. The conversion module 416 is then configured to convert the electrical signal component output by the suppression element 414 into a signal component with digital data. The filtering module 418 is used to filter any bit errors from the signal component output by the conversion module 416. The output channel 406 is configured to output the signal component with digital data, for example, to the control device of the accessory or to the control device of the basic appliance.

Active electronic components of the integrated circuit 400, such as the oscillator 410, are supplied with power by means of a supply connection, for example, the supply connection of the basic appliance, or by means of the power supplier of the accessory.

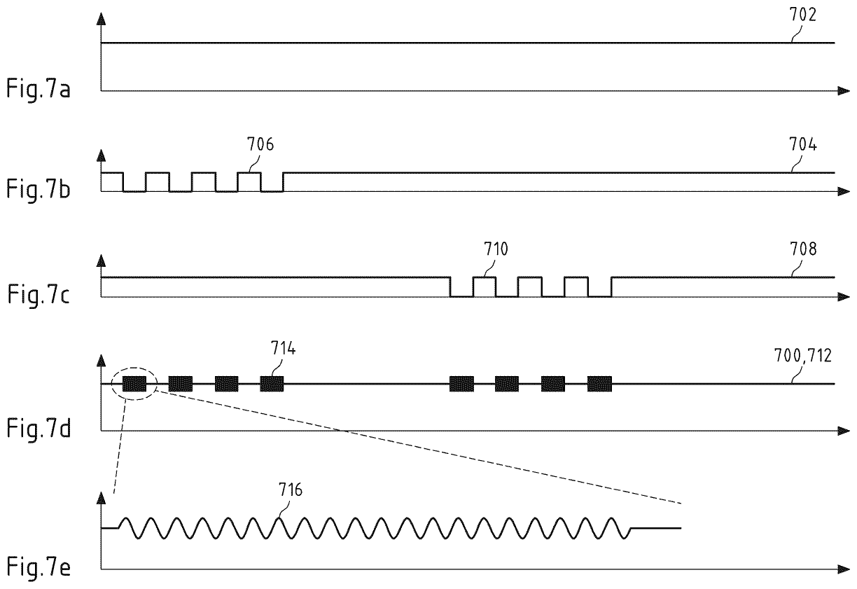

FIGS. 7a to 7e show a schematic representation of an embodiment for an electrical signal 700, which is transmitted in the system 600 of FIG. 5. The signal 700 is suitable for bidirectional data transmission respectively for communication in so-called half-duplex between the accessory 602 and the basic appliance 604.

FIG. 7a shows a first output signal 702, which is fed into the signal processing unit of either the accessory or the basic appliance and modulated there. The first output signal 702 is an electrical signal and has a base voltage of approx. 12 V.

FIG. 7b shows a second output signal 704, which is provided by the control device 624 of the accessory and fed into the signal processing unit 625 of the accessory. The second output signal 704 has individual pulses 706 which correspond to data, possibly for example, measurement data in digital form. The data can be transmitted in coded form by means of a UART protocol.

FIG. 7c shows a third output signal 708, which is provided by the control device 606 of the basic appliance and fed into the signal processing unit 605 of the basic appliance. The third output signal 708 has individual pulses 710, which correspond to data in digital form, possibly for example, control information pieces.

FIG. 7d shows an electrical signal 712 having modulations 714 by both the signal processing unit 605 of the basic appliance and the signal processing unit 625 of the accessory. Thus, the electrical signal 712 comprises the basic voltage of the first output signal 702 and modulations 714 corresponding to the digital data of the second output signal 704 and the third output signal 708.

FIG. 7e shows an enlarged section of the modulated signal 712 from FIG. 7d. This shows the modulation 714, which corresponds to an on-off key modulation 716.

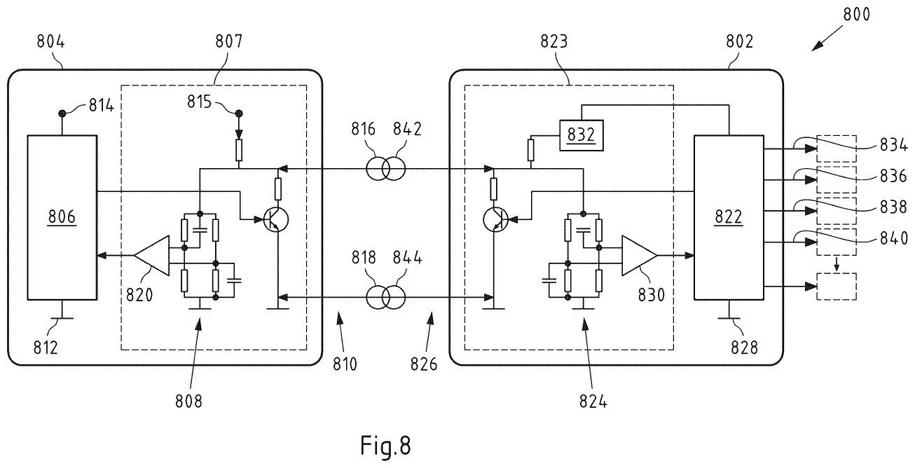

FIG. 8 shows a second embodiment of a circuit diagram of a system 800 with an accessory 802 and with a basic appliance 804 in a schematic representation.

On the left-hand side of FIG. 8, the basic appliance 804 and electrical components of the basic appliance, respectively, are shown schematically. This comprises a control device 806 and a signal processing unit 807. The signal processing unit 807 in turn comprises an operational amplifier circuit 808 and a contact module 810. The control device 806, the operational amplifier circuit 808 and the contact module 810 are each earthed by means of an earthing contact, such as the earthing contact 812 of the operational amplifier circuit 808. The control device 806 is energized by means of a supply connection 814, for example, approx. 3.3 V. In addition, the contact module 810 is connected by means of a further supply connection 815, which provides a basic voltage, for example, approx. 12 V. The contact module 810 comprises a first contact element 816 and a second contact element 818.

The control device 806 is connected to the contact module 810 for signal transmission to the accessory, i.e., in the transmitting direction. For the receiving direction, i.e., for receiving a signal from the accessory, the contact module 810 is connected to the operational amplifier circuit 808, which comprises a comparator 820. The operational amplifier circuit 808 is in turn connected to the control device 806.

On the right-hand side of FIG. 8, the accessory 802 and electrical components of the accessory, respectively, are shown schematically. This comprises a control device 822 and a signal processing unit 823. The signal processing unit 823 in turn comprises an operational amplifier circuit 824 and a contact module 826. The control device 822, the operational amplifier circuit 824 and the contact module 826 are each earthed by means of an earthing contact, such as the earthing contact 828 of the operational amplifier circuit 824. The operational amplifier circuit 824 on the part of the accessory is configured similarly to the operational amplifier circuit 808 on the part of the basic appliance, and also comprises a comparator 830. In addition, the signal processing unit 823 on the part of the accessory comprises a voltage supplier 832 in the form of a so-called “low drop-out” (LDO). The control unit 822 comprises connections 834, 836, 838, 840 with sensors, for example, Hall sensors and temperature sensors.

The contact module 826 comprises a first contact element 842 and a second contact element 844. The contact module 826 is connected to the operational amplifier circuit 824, which in turn is connected to the control device 822. In use, the voltage supplier 832 and the LDO, respectively, extracts a voltage, for example, approximately 3.3 V, from a signal provided by the basic appliance. This voltage is extracted based on the first signal component of the signal. This extracted voltage is then made available to the electrically operated elements of the accessory, in this case the control device 822 and sensors connected to the control device 822.

The control device 822 is connected to the contact module 826 for signal transmission to the basic appliance. In addition, the control device 822 is connected to the operational amplifier circuit 824 and to the contact module 826 in order to receive a signal and to extract the second signal component of the received signal and determine data therefrom.

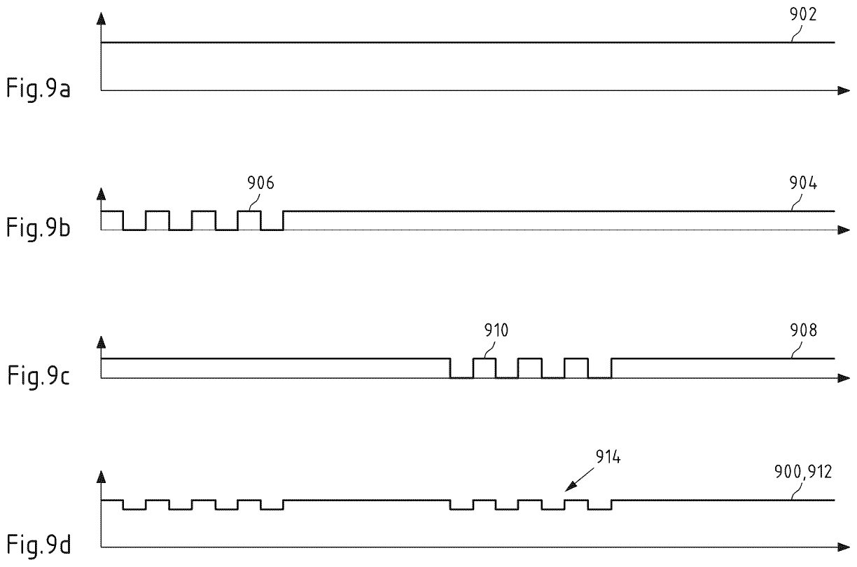

FIGS. 9a to 9d show a schematic representation of an embodiment for an electrical signal 900, which is transmitted in the system 800 of FIG. 8. The signal 900 is suitable for a bidirectional data transmission respectively for communication in so-called half-duplex between the accessory 802 and the basic appliance 804.

FIG. 9a shows a first output signal 902 with a basic voltage that is applied between the basic appliance and the accessory and their contact modules, respectively. Preferably, this basic voltage is provided by the basic appliance. In the example shown in FIG. 9a, the first output signal 902 has a basic voltage of approx. 12 V.

FIG. 9b shows a second output signal 904, which is provided by the control device 822 of the accessory and fed into the operational amplifier circuit 824 of the accessory. The second output signal 904 has individual pulses 906 which correspond to data, possibly for example, measurement data. The data can be transmitted in coded form by means of a UART protocol.

FIG. 9c shows a third output signal 908, which is provided by the control device 806 of the basic appliance and fed into the operational amplifier circuit 808 of the basic appliance. The third output signal 908 has individual pulses 910 that correspond to data, possibly for example, control information pieces.

FIG. 9d shows a modulated signal 912 output by the operational amplifier circuits respectively based on the first output signal 902 and the second output signal 904 respectively based on the first output signal 902 and the third output signal 908. Thus, the modulated signal 912 corresponds to the first output signal 902 with a modulation 914 according to both the second output signal 904 and the third output signal 908. As a result, the modulated signal 912 corresponds to the basic signal 902 superimposed with a modulation 914 corresponding to the individual pulses 906 from the second output signal 904 and the individual pulses 910 from the third output signal 908.

In use, the signal 900 is made available, for example, by the basic appliance as shown in FIG. 8 and transmitted by means of the contact modules of the basic appliance and an accessory that are brought into contact—as also shown in FIG. 8. The operational amplifier circuit of the accessory then filters the modulations using a high-pass filter and a low-pass filter in order to then provide the second signal component extracted in this way to the control device of the accessory. In addition, the voltage supplier and the LDO, respectively, extracts the first signal component, which corresponds to the first output signal as shown in FIG. 9a, in order to supply the control device of the accessory with energy.

What is claimed is:

1. An accessory for a kitchen appliance,
with a housing and
with at least one electrically operated element,
wherein a contact module is provided,
wherein the contact module is configured for electrical contact with a contact module of a basic appliance of the kitchen appliance and for receiving an electrical signal by means of the electrical contact, and
wherein a signal processing unit is provided,
wherein the signal processing unit is configured to output a first signal component for supplying power to the at least one electrically operated element on the basis of the received signal and to output a second signal component with data on the basis of the received signal.

2. The accessory according to claim 1,
wherein
a control device is provided, and
the control device is configured to determine the data from the second signal component output by the signal processing unit.

3. The accessory according to claim 1,
wherein
the data corresponds to control information pieces for the at least one electrically operated element.

4. The accessory according to claim 1,
wherein
the signal processing unit is configured to output a modulated electrical signal on the basis of a basic signal transmitted by contact with the basic appliance, wherein
the modulated electrical signal comprises a signal component with data, and
the contact module is configured to transmit the modulated electrical signal output by the signal processing unit to the basic appliance by means of the electrical contact.

5. The accessory according to claim 4,
wherein
at least one sensor is provided for outputting measurement data, and
the data of the signal component of the modulated electrical signal output by the signal processing unit corresponds to the measurement data.

6. The accessory according to claim 1,
wherein
the contact module comprises a first contact element and a second contact element.

7. The accessory according to claim 1,
wherein
a receiving area having a wall is provided for receiving foodstuffs,
a component is arranged at the wall, and
the at least one electrically operated element is integrated in the component.

8. A basic appliance for a kitchen appliance
with a housing and
with a power supply element,
wherein a signal processing unit is provided,
wherein the signal processing unit is configured to output an electrical signal with a first signal component and with a second signal component,
wherein the first signal component is configured to supply power to at least one electrically operated element of an accessory, and
wherein the second signal component comprises data,
wherein a contact module is provided,
wherein the contact module is configured for an electrical contact with a contact module of the accessory for a kitchen appliance,
wherein the contact module is configured to transmit the electrical signal by means of the electrical contact.

9. The basic appliance according to claim 8,
wherein
a control device is provided,
the control device is configured to output control information pieces, and
the signal processing unit is configured to modulate and to output the electrical signal to be transmitted by the contact module in such a way that the data of the second signal component correspond to the control information pieces.

10. The basic appliance according to claim 8,
wherein
the contact module is configured to receive an electrically modulated signal by means of the electrical contact, and
the signal processing unit is configured to output a signal component with digital data on the basis of the received modulated signal.

11. The basic appliance according to claim 8,
wherein
the contact module comprises a first contact element and a second contact element.

12. A kitchen appliance
with an accessory according to claim 1 and
with a basic appliance.

13. A method for operating a kitchen appliance with a basic appliance and with an accessory,
in which an electrical connection is formed between the basic appliance and the accessory by bringing a contact module of the basic appliance and a contact module of the accessory into contact,
in which a first electrical signal is transmitted from the basic appliance to the accessory by means of the electrical connection,
in which at least one electrically operated element of the accessory is supplied based on the transmitted first signal, and
in which data is determined by a control device of the accessory and on the basis of the transmitted first signal.

14. The method according to claim 13,
in which a second electrical signal is transmitted from the accessory to the basic appliance by means of the electrical connection, and
in which data is determined by a control device of the basic appliance and on the basis of the second signal.

15. A signal processing unit for a kitchen appliance,
with a contact module and
with an integrated circuit for processing mixed signals or with an operational amplifier circuit,
wherein the contact module comprises a first contact element and a second contact element,
wherein the contact module is connected to the integrated circuit or to the operational amplifier circuit, and
wherein the signal processing unit is configured, on the one hand, to process a signal and output it to the contact module in such a way that the signal has a first signal component for supplying power to an electrically operated element and a second signal component with data, and on the other hand to output a signal component with data on the basis of a signal received by the contact module.

16. The accessory according to claim 4,
wherein
the signal processing unit is configured to output a modulated electrical signal on
the basis of a basic voltage applied by contact with the basic appliance.

17. The basic appliance according to claim 8,
wherein
the contact module is configured for an electrical contact with a contact module of an accessory.
